(19) United States
(12) Patent Application Publication
(10) Pub. No.: US 2004/0123247 A1
(43) Pub. Date: Jun. 24, 2004

(54) Method and apparatus for dynamically altering electronic content

(75) Inventors: Mark Wachen, Ardsley, NY (US); Lance Lovette, New York, NY (US)

Correspondence Address: BAKER & HOSTETLER LLP, Suite 1100, Washington Square, 1050 Connecticut Avenue N.W., Washington, DC, 20036, US

(73) Assignee: Optimost LLC

(21) Appl. No.: 10/409,128

(22) Filed: Apr. 9, 2003

Related U.S. Application Data
(60) Provisional application No. 60/434,658, filed on Dec. 20, 2002.

(51) Int. Cl. G06F 17/21

(52) U.S. Cl. 715/530; 715/531

(57) ABSTRACT

A method and apparatus for altering electronic content includes a template for assigning variables and values to a section of the content, a generator that creates the permutations of the content, a transmitter that provides the content to a requestor and a evaluator and optimizer that aids in selecting the most optimal permutation of the content.

### PRIORITY

This application claims priority to the provisional U.S. patent application entitled, Method and Apparatus for Dynamically Altering Content, filed Dec. 20, 2002, having a Ser. No. 60/434,468, the disclosure of which is hereby incorporated by reference.

### FIELD OF THE INVENTION

The present invention relates generally to a method and apparatus for changing electronic content. More particularly, the present invention relates to dynamically generating and testing permutations of electronic content to determine optimal combinations of content.

### BACKGROUND OF THE INVENTION

The Internet provides content providers the ability to offer endless amounts of information to the public. As originally implemented, little consideration was given to the presentation of data on the Internet. As the Internet has became more of a business tool, as a channel for selling goods and services, more thought was given to the presentation of the content.

One possible avenue for revenue generation on websites is advertising or renting space on a website for a fee or selling products or services on a website. Positive revenue generation was also linked with arranging or altering content in an efficient manner. In order for the content to be effective, the content needs to attract customers or visitors. Therefore, the arrangement and placement of content has become more and more a business decision.

Initially, content requestors were provided with the content in the same way. For example, a visitor to a search engine site would be able to see the identical content format as another requester of the same site. This tool only allowed the content provider to try one particular advertisement or creative execution at a time. With such a system, initial advertisement response rate began to shrink over time. Furthermore, the customer acquisition costs online was starting to become equal if not more than an offline customer. Such a scenario was making it difficult for companies to continue their online advertisement budgets.

In response to this, companies began to provide a set number of content layouts for the requestor. Each time a requestor would request the content, the requester would receive one of these versions. The versions would offer some variation of the content. The degree of the variation would depend on the content provider. However, this method, even though improved, still lacked in providing effective content which would have the effect of figuring out the best way of attracting customers to the companies products or services. The reliability of the response rates to the different versions of the content was difficult to ascertain due to the nonsystematic varying of multiple elements simultaneously across a limited number of different versions.

Other prior art systems began to arrive that offered content optimization and real-time fine-tuning. The creative optimization tended to be time consuming and expensive. This method dictated that the content providers manually generate all the different versions of the content. In many instances, the content provider would employ an individual to monitor and alter the content. The individual would manually create a variety of graphical representations of the content. However, the content providers were still only providing a limited number of versions to the public, which once again limited the reliability of their statistical data.

Another prior art system was the ability to fine-tune the content on a real-time basis. The content provider would physically alter the permutations used. To do this, the content provider would make an assessment of the permutations and select those that he thought would attract the most customers.

In each of the above processes, the prior art was limited by a number of things. One was the lack of automation in the process itself. Another was the inability of the system to generate and test a sufficient data sample in order to give reliable statistical information. The Internet, unlike any other medium, held out the promise that content providers would have the ability to alter or change the content with little or any problem.

Accordingly, it is desirable to provide a method and system with the ability to create essentially limitless permutations at a fraction of the costs as well as an automated optimization system.

### SUMMARY OF THE INVENTION

It is therefore a feature and advantage of the present invention to provide a method and apparatus to be able to create essentially limitless permutations of electronic content.

It is another feature and advantage of the present invention to provide a method and apparatus for allowing a content provider to view the different permutations as well as gather statistical information on the permutations to aid in determining which permutations are attracting new and current customers to their products or services.

The above and other features and advantages are achieved through the use of a novel system that allows the content provider to define a variable and associated values with these variables and then proceed to automatically create essentially limitless permutations of content as herein disclosed. In accordance with one embodiment of the present invention, a method for altering content is provided with the steps of placing content within a template, placing at least one or more variables within the template, calculating permutations for the content based upon the values, transmitting the permutations a single one at a time and evaluating the permutations.

Further steps to this embodiment can include optimizing the number of the permutations evaluated. After the initial set of permutations is created, they are presented to requesters of the content. The configuration of the content and the number of requests for the content is tracked and presented to the content provider.

This embodiment further includes reducing the permutations evaluated based upon an analysis of the tracked results. Once this is done, the permutations that were more successful are re-run and/or altered based on their statistical data. In this second or subsequent run of a new set of permutations, another evaluation is completed on the new set of permutations. The goal of the subsequent runs is to reduce the number of permutations evaluated and provide content that is most effective at attracting customers or clients.

A variable is selected from within the content itself. Control templates can be included as templates related to a particular template whose variables are analyzed along with their master template. Such a set-up gives the system flexibility to define a relationship between templates.

The present invention does allow the agency or content provider that has declared multiple variables the ability to ensure that multiple variables will not contain the same value in a permutation. As a result, the variables have a relationship or dependency upon each other. The present embodiment can further include the steps of selecting a covariable and subvariable from within the content. Similar to the variable, a plurality of values can be chosen for the covariables and subvariables. The present embodiment also includes the step of dynamically selecting a new permutation each time the content is accessed. In other words, after the apparatus creates a number of permutations, a new or different one is delivered to the requestor each time a request is received. Each time the request is made statistics are then kept on how that permutation is performing.

In an alternate embodiment of the present invention, an apparatus for altering content includes means for placing content within a template, means for placing a variable within the template, means for calculating permutations for the content based upon the values, means for transmitting the permutations a single one at a time and means for evaluating the permutation.

The apparatus can further include means for reducing the number of the permutations to a new set and means for transmitting the new set. Similar to the original set of permutations, means for evaluating the new set of permutations is provided so that statistical data is stored and viewed.

The content in this alternate embodiment includes a means for creating a template. In creating a plurality of variables within this template, the alternate embodiment enables the agency or content provider to ensure that these variables are not equal as to their values. Such an ability means that the variables relate to one another.

This alternate embodiment can further include means for selecting a covariable for the variable and means for choosing a value for the covariable. Additionally, means for dynamically selecting a new permutation each time it is accessed can be included with this alternate embodiment.

In a further alternate embodiment, a computer readable medium includes the step of placing content within a template, placing a variable within the template, choosing a plurality of values for the variable, calculating permutations for the content based upon the values, transmitting the permutations a single one at a time and evaluating the permutations. Further steps within the computer readable medium can include reducing the number of the permutations to a new set of permutations as well as transmitting the new set to a requestor. Once the new set of permutations has been determined, the computer medium begins the step of evaluating the new set of permutations. The computer readable medium can further provide the step of selecting a variable in the template. The content is placed within a template, which can be text, mosaic, montage or a control. Within the content, the computer readable medium allows the agency or content provider to ensure that a permutation will not insert identical values for different variable. In essence, the variables are related in some form. The computer readable medium permits the step of selecting a covariable and choosing a plurality of values for the covariable. It further allows the step of selecting a subvariable for the covariable and choosing a plurality of values for the covariable.

The computer readable medium can include the step of dynamically selecting a new permutation each time the content is accessed or requested. In a further embodiment, a computer processing device for optimizing content includes a memory location wherein the content is located, a selector linked to the memory location, wherein the selector allows a variable to be placed within the template, an identifier linked to the selector, wherein the identifier allows a plurality of values to be chosen for the variable, a generator linked to the memory location, selector and the identifier, wherein the generator creates permutations for the content based upon the variable and the plurality of values, a transmitter linked to the generator that transmits one of the permutations to a requestor and an evaluator linked to the generator.

This embodiment can also include a receiver configured to receive a request from the requestor for access to the content and an optimizer that is linked to the generator and evaluates the permutations. The evaluation can be based on the click-thru rates. Based on the statistical data of the click-thru rates, the optimizer reduces the number of the permutations available to the requester.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram illustrating the differing modules of the present invention.

FIG. 2 illustrates a specific application of the present invention.

FIG. 3 illustrates another specific application of the present invention.

FIG. 4 is illustration of assembling an advertisement with the present invention.

FIG. 5 is a flow diagram of the present invention illustrating the optimization process.

FIG. 6 is illustration of the reporting tier of the present invention.

FIG. 7 is an illustration of an embodiment of the invention.

FIG. 8 is an illustration of an alternate embodiment of the embodiment of FIG. 7.

FIG. 9 is an illustration of an alternate embodiment of the embodiment of FIG. 7.

### DETAILED DESCRIPTION OF PREFERRED EMBODIMENTS OF THE INVENTION

A preferred embodiment of the present invention provides a method and apparatus that enables a agency or content provider to create a variable within content and assign values to the variable. From this, a number of permutations are created for the content, which are then transmitted to a requestor. Statistical data is kept on the permutations, which enables the system to reduce those permutations to a set that is most effective.

In describing the invention, it is important to describe or define a few terms of art that are used throughout this section. The first is a creative. A creative is defined as a block of content in which a content provider or agency has altered or arranged the content in a different fashion or manner. To accomplish this task, variables were placed among the content. The variables are specific areas of content to which values are assigned. The assigned values serve to create different permutations of the content, which in essence are creatives. With each permutation of the content, a different assigned value is chosen for each variable and placed within the content. It is important to note that makeup of the content is not limited to text. The content can be but is not limited to pictures, symbols, animation, clip art and colors. Furthermore, the content can be links, registrations, or overall arrangement of the content.

Another term is an agency. An agency is effectively the provider of the content. The agency provides the content that is placed on a website. An agency can have a number of creatives running simultaneously. Each agency has a campaign in which an action plan is put into place. A campaign is composed of creatives. A campaign can have one or more creatives.

Once the content has been placed on the website, the content is monitored in order to determine its effectiveness. Effectiveness is a agency or content provider-defined term. One agency or content provider method can be vastly different from another one. One way to determine the effectiveness is by the click-thru rate. The click-thru rate is defined by an individual actually clicking on the content, which is turn usually takes them to a different uniform resource locator (URL). A click-thru rate is essentially a counter in which the present invention records the number of requests for that particular portion of the content. Note that the click-thru rate is only one possible area for statistical analysis. Another could be received registrations, requests or orders. Another success rate could be the total number of registrations collected or even something such as the lack of technical questions received from customers of a product.

The invention at its most generic sense provides a template to which content is placed. Within the content, factors or variables are selected. The variables provide the agency or content provider with the ability to alter or change the content based on the values chosen for the variables. The template provides the basis for which the system begins to provide differing version of the content based upon the variables and factors placed within the content. As requests for the content are received, the invention dynamically alters the content based upon the variables chosen and the related values.

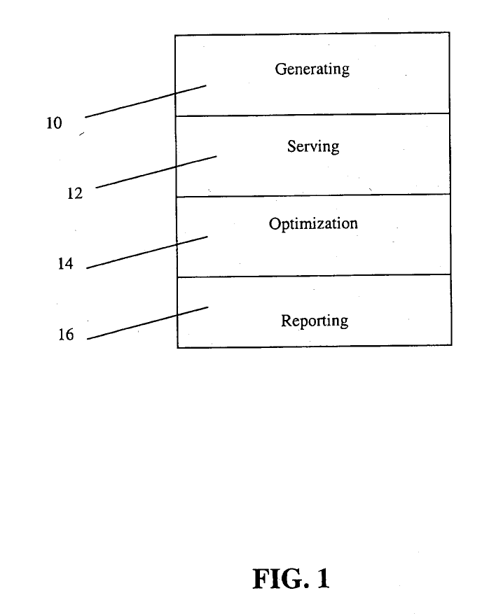

FIG. 1 is a block diagram of the tiers of the present invention. The present invention is comprised of four service modules or tiers. They are generation 10, serving 12, optimization 14 and reporting 16. The modules are managed independently of the others and effectively self-sufficient. The generation tier 10 composes a set of creatives from a template that are processed in the system. The serving tier 12 responds to the requests for these creatives and ensures that they are delivered. Each request for a creative is recorded for the optimization process. The performance of this tier enables the invention to process effective creatives for the content provider or agency. The serving tier 12 also handles requests for click-thrus or any other type of action that the agency or content provider desires and records the action.

The system can perform serving and recording functions without being influenced by other parts of the system. In other words, if the reporting tier 18 is taken offline, then this would not affect the serving tier.

The optimization tier 16 analyzes the data recorded by the serving tier 10 and determines how the creatives should be changed or altered to increase the effectiveness.

The reporting tier 18 is an end agency or content provider's view into the system. This tier 18 allows an agency or content provider to view how the creatives or campaigns are performing. In other words, the reporting tier 18 allows the data gathered on the content to be reported. This data gathered can be in the form of statistical calculations, as in the preferred embodiment. However, the type of data collection is effectively based upon the content provider. The content provider is able to dictate to the present invention the type of data they wish to be collected.

The present invention provides a separate section for each content provider or agency. The system is then focused on running creatives based on the input from the content provider or agency. A system can allow various agencies to be independent from one another. In the preferred embodiment, each agency or content provider would have their own database. However, the present invention encompasses a system in which a single database is used. In either scenario, each agency or content provider is able to run independently of the others. Each agency or content provider can run more than one creative or campaign at one time.

One of the elements of the present invention are creative templates. The. templates enable the present invention to be flexible and powerful. Templates incorporate the use of variables within side them to allow the agency or content provider to perform any number of substitutions. This in turn allows the agency or content provider to create essentially a limitless amount of variations of content. A template is where the content is held or placed.

Content is placed in the template and to where variable are selected, identified or placed. The variables provide the content provider with the ability to alter the content to whatever values are chosen. The content, not chosen as a variable, is fixed and remains stable throughout the different permutations. The following is an explanation of how the present invention changes the content through the use of templates and variables.

Initially, the content is placed with the template. Once this is done, variables are identified by the content provider and then values are assigned to the variables. With each request for the content, the present invention provides a differing version of the content based upon the variables and the fixed portion of the content. It is possible to create a template with no variables but it cannot be optimized. In the preferred embodiment, it is possible to create a template that contains more than one click-thru.

In the preferred embodiment, a variable that is not referenced in a template should not be included in the optimization. In the preferred embodiment, the variable is removed in order to keep it from unnecessarily increasing the number of possible creatives.

The number of creatives or permutations for a template depends on the variables, their type, the number of values for the variables and the relationships between the variables. For example, a template with k simple variables with no dependencies has Pₓ permutations for each individual variable. The product of the variable permutations determines the template permutations:

P=P₁*P₂*P₃* . . . *Pₖ

When a template includes variables with dependencies such as variables with non-equality rules or subvariables, there exists relationships between the variables and permutations that cannot be calculated using the individual variable permutations. For example, if there is a relationship between variables 1 and 2, the calculations must include the permutations for those variables together:

P=P₁₂*P₃* . . . *Pₖ

Furthermore, if a relationship exists between variables 1, 2 and 3, the permutations would be:

P=P₁₂₃* . . . *Pₖ

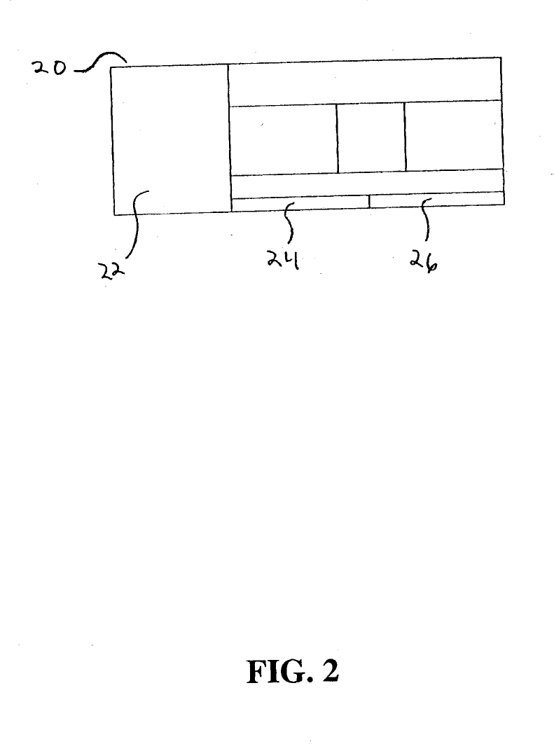

The following is an example of the implementation of the template. In this implementation, the templates are used to generate creatives or permutations in which the content is non-text such as images. This advertisement 20 is the popup advertisement that is popular when surfing the Internet. If you examine the advertisement 20, it would appear to be a large monolithic image. However, as the figure show, it is not classified as an image. As FIG. 2 illustrates, it is a table with eight sections. Each section of the template contains a small section of the creative. For example, a first section that would be a person 22, who appears in the advertisement, is actually a Flash animation. A “more info” content 24 is an animated GIF with the arrows 26 being a Flash animation as well.

Parsing up the creative in this manner enables a requester to download multiple sections of the creative simultaneously. Furthermore, it provides the content provider or agency with the ability to use varying technologies for each section of the template. In the preferred embodiment, the media format of this template is hypertext markup language (HTML).

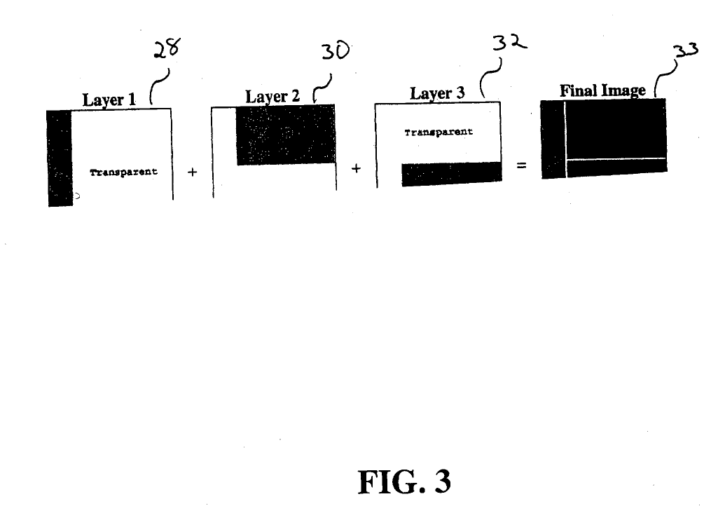

Another implementation of the template design in the preferred embodiment is in FIG. 3. The alternate embodiment of the template enables the agency or content provider to generate image creatives from a series of individual images. To generate this template, the image is divided into a series of layers. Each layer has a series of images associated with it. By joining or combining the layers, the system creates a composite image for each creative.

Referring to FIG. 3, the image has been divided into three layers 28, 30, 32. By doing so, the content provider can determine which combination of images work best. Layer 1 contains the image A 28, which covers the left side of the template 32. Layer two contains the image B 30 and layer three contains image C 32. The combination of these layers forms the template 33.

If the content provider desires five different images for A 28, five images for B 30 and ten images for C 32, then the graphic designer only needs to create twenty images. However, with the present invention, the agency or content provider has the ability to test two hundred and fifty different creatives. Layers two and higher in FIG. 3 are transparent in certain areas to allow lower layers to be visible. In the preferred embodiment, the media format can be JPEG, PNG or GIF. Additionally, the montage template has one uniform resource locator (URL) that is the destination of click-thrus. However, as one of ordinary skill is the art recognizes more than one URL is possible.

Other types of templates implementations are within the scope of the present invention. For example, it is possible to have a template that would incorporate the use of compute software code that is used for popup and popunder creatives such as JavaScripts. In this embodiment, the template, is associated with a master template and does not have its own independent variables. The variable for this template are peer to master variables. Each instance of a this template is called a control creative, which is associated with one creative. The variables within this template are analyzed along with master variables.

In order to create a number of permutations for content, the agency or content provider must first assign a variable within the content itself. The types of variable that can be used are simple, covariables, subvariables and peer. To start the optimization process, the content must first contain a variable. The following sentence or content is used to explain a template with a simple variable.

Today is a great day!

The content provider or agency wants to create variations of this sentence by altering the adjective describing the noun day and therefore creates a template. In the present invention, the following expression is written to create both a variable for the adjective describing the type of day and a template.

Today is a {$adjective}day!

Upon creating a variable for the adjective within the template, values are then chosen for each variable. The adjectives, in this example, are chosen to be great, wonderful, fantastic and lovely. The expression is written as:

Adjective=great, wonderful, fantastic, lovely

The system then creates four different permutations for the phrase. They are:

Today is a great day!

Today is a wonderful day!

Today is a fantastic day!

Today is a lovely day!

As a request for the data is received, the present invention selects one of the above permutations to provide to the requestor. Each time a request is made the inventions dynamically alters the content based on the template created by the content provider.

The generation tier 10 is given the content of which a portion is fixed and a portion of which variables and corresponding values are assigned. The serving tier 12 then transmits one of permutations to a requestor. The optimization tier 14 records the requests and begins to gather statistical data. In the preferred embodiment, the statistical analysis is based upon the click-thru rate. All of the statistical analysis is compiled and reported to the content provider in the reporting tier 16.

Besides replacing text, the preferred embodiment enables the content provider to alter the format of the text. One such example is the changing of HTML format of a sentence. The following is example of using a template and variable to alter the format of the content. By supplying the content and the HTML code, a template is created.

<span style=“font:bold italic Times New Roman;”>Buy Flowers for Mother's Day</span>

In this instance, font attributes of the tag are replaced with variables. This allows the content provider to create any number of permutations.

<span style=“font:{$weight} {$style} {$family};”>Buy Flowers for Mother's Day</span>

The values are then assigned for the variables. The following sets of values for the variables create twenty different permutations of the sentence.

Weight=normal, bold

style=normal, italic

family=Arial, System, Courier New, Times New Roman, Tahoma

As a request for the data is received, the present invention selects one of the above permutations to provide to the requester. Each time a request is made the inventions dynamically alters the content based on the template created by the content provider.

In the preferred embodiment, a template, which is comprised of text, can contain text formats of varying degrees. The formats can be, but not limited to, plain text, rich text such as HTML, XML and JavaScript. The template can have any number of variables with each variable having any number of values for substitution. The use of variables allows the content provider to automatically create and test limitless permutations of electronic content. Any part of the text within the template can be replaced with a variable. The same variable can be referenced multiple times within the template.

The permutations for a simple variable with N values is equal to N.

P=N

In the preferred embodiment, variables can have a non-equality rule. This rule ensures the variables within the same creative are not given the same value. The following sentence is used to illustrate the use of this rule:

Buy Flower's for Mother's Day

In creating a template, the content provider or agency necessitates that each permutation have either the phrase “Buy Flowers” or “Mother's Day” in bold but not both. This is accomplished in the preferred embodiment by first placing the content within the template and creating two variables, weight1 and weight2, each with values normal and bold.

<span style=“font: { $weight1 };”>Buy Flowers</span> for

<span style=“font: { $weight2 };”>Mother's Day</span>

A rule is then set that the value of weight1 cannot equal the value of weight2. In this instance, the variable weight1 is the dependent variable so the system picks a value for weight2 first. The value of weight1 is based on the value selected for weight2. Since both variables have the same values, the system alternates the bolding property between the two phrases.

A non-equality rule creates a dependency relationship between variables. In order to simplify the permutation math and logic in the preferred embodiment, the non-equality rule is limited to a depth of one and each master variable can only contain a single non-equality rule. However, one of ordinary skill of the art recognizes the ability to allow non-equality rules to have a depth greater than one and allow each master variable to contain more than one non-equality rule. A variable cannot be dependent on the value of another dependent variable or a master variable with peer variables. Dependent variables include covariable, subvariables and variable with a non-equality rule. In other words, a variable cannot be both dependent and independent at the same time. This aids in preventing recursive dependencies, where a variable is dependent on a variable that is dependent on the first variable. When choosing values, independent variables are evaluated before dependent values.

The following table is a summary of the types of rules that can be enforced in the preferred embodiment.

| Legal | Illegal |
|---|---|
| A ≠ B | A ≠ B and B ≠ C |
| | A ≠ B and B ≠ C and C ≠ D |
| | A ≠ B and B ≠ A |

Non-equality rules create relationships between variables For example, if the variable A and B have N_{A} and N_{B} values respectively and C_{AB} values in common and a rule exists that A cannot equal B, then the individual permutations P_{A} and P_{B} are replaced with combined P_{AB}. The calculation of P_{AB} is

P_{AB}=(N_{A}*N_{B})−C_{AB}

Covariables are considered a subset of a variable. In other words, covariables are value attributes. The following example is an illustration of the implementation of covariables into the preferred embodiment.

Today's special is 4 CDs for $1!

Today's special is 2 DVDs for $4!

Today's special is 8 Books for $10!

A variable is created for the product, i.e., CD, DVD, Book. The problem arises that the numerical quantity of product and the dollar amount are dependent on the actual product. If quantity and price variables are created, then the template would be:

Today's special is {$quantity} {$product} for {$price}!

If it is structured in this manner, then one of the permutations could be the following permutation:

Today's special is 8 DVDs for $1

This is an unacceptable permutation of the template.

What is needed and missing in the template to avoid this type of permutation is a relationship structure between product, quantity and price. Covariables allow the agency or content provider to specify that the quantity related to CDs is 4 and the price is $1 and the quantity related to DVDs is 2 and the price is $4.

Covariables

| Master Values | Quantity | Price |
|---|---|---|
| CDs | 4 | $1 |
| DVDs | 2 | $4 |
| Books | 8 | $10 |

This relationship is expressed in the preferred embodiment as follows:

Today's special is {$product.quantity} {$product.product} for {$product.price}!

In the instance of covariables, permutations are based upon the master variable, which in the above example is the product. After a value is selected, the system assigns its covariables to the variable, which are referenced in the template using the syntax {$variable.covariable}. If a master variable has covariables, then the master variable value itself is referenced using the syntax {$variable.variable}.

Covariables do not increase the number of creative permutations. Furthermore, they are not included in the analysis, optimizations or reports. A variable can have zero or more covariables. Since covariables are simply master variable attributes, they cannot have a non-equality rule, covariables, subvariables or peer variables. This means that covariables cannot have covariables, covariables cannot have subvariables and covariables cannot have peer variables.

In the preferred embodiment, subvariables are also available to the agency or content provider. Subvariables allow the agency or content provider to specify a different dependency relationship between values. In essence, subvariables are value restrictions. The following sentences are used to illustrate the usage of subvariables.

Today's special is 4 CDs for $1!

Today's special is 4 CDs for only one dollar!

Today's special is 2 DVDs for $4!

Today's special is 2 DVDs for less than five bucks!

Today's special is 8 Books for $10!

Today's special is 8 Books for ten dollars!

The relationship between product and quantity is fixed and defined with a covariable. In this example, the relationship between product and price is more complicated. When the permutation chooses CD as a product, then it must choose either of the values “$1” or “only one dollar”. Subvariables allow the agency or content provider to restrict values based upon the value of the master variable. The following table defines the relationships between the master and subvariables values.

| Master | Subvariables | | | | | |
|---|---|---|---|---|---|---|
| Values | $1 | only a dollar | $4 | less than five bucks | $10 | ten dollars |
| CDs | ✓ | ✓ | | | | |
| DVDs | | | ✓ | ✓ | | |
| Books | | | | | ✓ | ✓ |

The price subvariable has six values but only certain values for specific products. The following syntax is used for using covariables.

Today's special is {$product.quantity} {$product.product} for {$product.price}!

The syntax {$product. product} references the master variable. The syntax {$product.quantity} references a master variable covariable and the syntax {$product.price} references the subvariable.

Since subvariables are dependent on their master variable, the master variable must be selected first. Subvariables are included in the analysis and optimization process along with the master value. A master variable can have zero or more subvariables. A master with subvariables can also have peer variables, covariables and a non-equality rule. If the agency or content provider wants master values to be distributed equally over the creative set, then each master value should have the same number of subvariable values.

In the preferred embodiment, if a master value has a subvariable, then it must be associated with more than one subvariable value. If the subvariable only has one value or contains values that are associated with the master values in a one-to-one relationship, the agency or content provider is prompted to use covariables.

Subvariables can have covariables. Covariables of subvariables are referenced using the syntax {$variable.subvariable.covariable}. If a subvariable has covariables, the subvariable value is referenced using the syntax {$variable.subvariable.covariable}. In the preferred embodiment, in order to simplify the permutation logic, subvariables themselves cannot have subvariables, peer variables or a non-equality rule. However, one of ordinary skill of the art recognizes the ability to allow subvariables to have subvariables, peer variables or a non-equality rule.

Since there are variable dependencies between master and subvariables, the permutations of a master variable and its subvariables are computed together. The following illustrates a master variable having a single subvariable.

| | |
|---|---|
| Master Variable = A | Subvariable = B |
| Maser Values = 1, 2, . . . k | Subvariable Values = B1, B2, B3 |

| A | B1 | B2 | B3 | |
|---|---|---|---|---|
| 1 | ✓ | ✓ | | N₁ = 2 |
| 2 | | ✓ | ✓ | N₂ = 2 |
| . | . | . | . | . |
| . | . | . | . | . |
| . | . | . | . | . |
| k | ✓ | ✓ | ✓ | Nₖ = 3 |

P_{AB} = N₁ N₂ = . . . N_{K}

Where N₁, N₂, . . . Nₖ define the number of valid subvariable values for each master value.

The following illustration is a master variable with two subvariables.

| A | B1 | B2 | B3 | C1 | C2 | C3 | |
|---|---|---|---|---|---|---|---|
| 1 | ✓ | ✓ | | ✓ | ✓ | ✓ | N_{b1} = 2; N_{c1} |
| 2 | | ✓ | ✓ | | ✓ | ✓ | N_{b2} = 2; N_{c2} |
| . . . | . . . | . . . | . . . | . . . | . . . | . . . | . . . |
| k | ✓ | ✓ | ✓ | ✓ | ✓ | ✓ | N_{bk} = 2; N_{ck=2} |

Master Variable = A
Maser Values = 1, 2, . . . k
Subvariable = B
Subvariable Values = B1, B2, B3
Subvariable = C
Subvariable Values = C1, C2, C3
P_{ABC} = (N_{B1} * N_{C1} * . . . ) + (N_{B2} * N_{C2} * . . . ) + . . . + (N_{Bk} * N_{Ck})

The equation, as detailed below, expands in the same manner with each additional subvariable.

P_{AB . . .} =(N_{B1}*N_{C1}* . . . )+(N_{B2}*N_{C2}* . . . )+ . . . +(N_{Bk}*N_{Ck}* . . . )

If the master variable has a non-equality rule, the combined permutations lose a permutation for each value of each subvariable for each overlapping value. For example, if master variable A is dependent on variable D, which has P_{D} permutations, and they have the value one in common, then the combined permutations in the case above is:

P_{ABD}=(P_{AB}*P_{D})−N₁

In the case where there are two subvariables, the combined permutations are:

P_{ABCD}=(P_{ABC}*P_{D})−(N_{B1}*N_{C1})

In the case where the variable have the value one and two in common, the combined permutations are:

P_{ABD}=(P_{ABC}*P_{D})−N₁*N₂

P_{ABCD}=(P_{ABC}*P_{D})−(N_{B1}*N_{C1})−(N_{B2}*N_{C2})

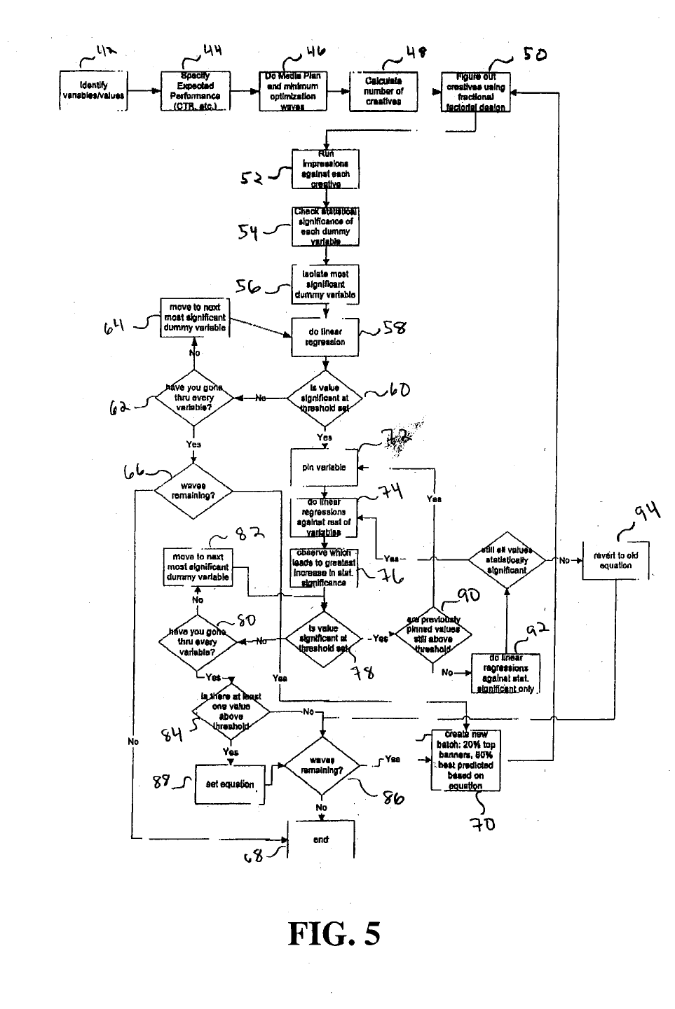

Peer variables enable the agency or content provider to assign disjoint values to a set of related variables. Referring to FIG. 5 as an example, let's assume that the agency or content provider has an advertisement in which they want to advertise computer models for sale. The template consists of four sections 34, 36, 38, 40. The first section 34 features a particular computer model. The other three sections are thumbnail descriptions of the products. The ultimate goal with this content is its arrangement. The content is arranged in such a way that a sufficient number of responses are received. To do this, the first step is to create a master variable and assign values. For example, the computer model values are: 4100, 3100, 1100, 400, 300, 2485.

The next step is to create covariables for each model so that an association e created between the model and the series, price and images. The following example rates one possible value set for the computer advertisement.

| | Covariables | | | |
|---|---|---|---|---|
| Master values | series | Price | largeImage | smallImage |
| 4100 | PowerMax | $1200.00 | /images/large4100.gif | /images/small4100.gif |
| 3100 | PowerMax | $1000.00 | /images/large3100.gif | /images/small3100.gif |
| 1100 | PowerPlus | $900.00 | /images/large1100.gif | /images/small1100.gif |
| 400 | ValueMax | $700.00 | /images/large400.gif | /images/small400.gif |
| 300 | ValueMax | $400.00 | /images/large300.gif | /images/small300.gif |
| 2485 | TravelMax | $1900.00 | /images/large2485.gif | /images/small2485.gif |

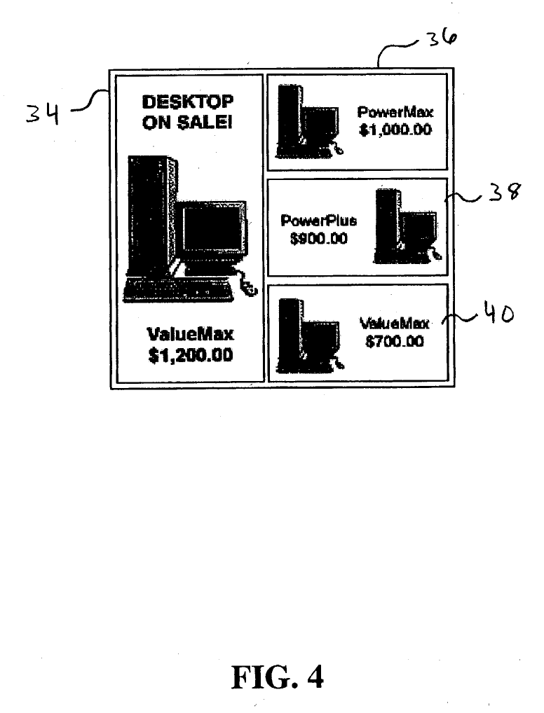

In the advertisement in FIG. 4, the agency or content provider wants to select four models in each advertisement. If four variables are created, model 1, model2, model3, model4, all with the same values, then a possible permutation would be the same values for each of the models. If more than one non-equality rules are created for each variable, then things would be kept in the proper order. However, this is burdensome since the agency or content provider would have to manage all the variables, their values and rules.

In the preferred embodiment, the advertisement is managed with peer variables. Peer variables allow the agency or content provider to create four variables that all have the same values but the same value cannot be selected for more than one variable. This keeps the variables from having the same value as another variable. Therefore, for this example, the four peer variables 1, 2, 3, 4, are created. This enables the different computer models to be referenced in the template. Peer variable values are referenced using the syntax {$variable.peervariable.variable} and covariables are referenced using the syntax {$variable.peervariable.covariable}

The following is an example of the advertisement in FIG. 4.

{$model.1.model}

{$model.1.largeImage}

{$model.1.series}

{$model.1.price}

{$model.[2,3,4].model}

{$model.[2,3,4].smallImage}

{$model.[2,3,4].series}

{$model.[2,3,4].price}

In this instance, since the master variable doesn't technically have a value, peer variables replace the master variable in the analysis, optimization and reports. In this case, the variables that are analyzed are model.1, model.2, model.3 and model.4.

Peer variables are also used to construct sentences or paragraphs. Take the following three-sentence paragraph for example:

You may be qualified for a No Security Deposit credit card that is EASY to get. A Great Way to Strengthen or Re-establish Your Credit! If you do not get approved for this card; you may not get approved anywhere else.

To test the order of the sentences for the best response, the paragraph is converted into a template. An example is the following:

{$sentence.1.sentence} {$sentence.2.sentence} {$sentence.3.sentence}

A variable is then created with three values and a peer variable for each sentence. The following is an example of the present invention implementing the three sentence:

Master variable=sentence

Peer variables=1, 2, 3

Master values:

1. You may be qualified for a No Security Deposit credit card that is EASY to get.

2. A Great Way to Strengthen or Re-establish Your Credit!

3. If you do not get approved for this card; you may not get approved anywhere else.

A master variable with peers can have covariables and subvariables. The master variable cannot have a non-equality rule because of the relationship between peer variables and master values. Enforcing the rule may cause the number of master values to be less than the number of peer variables so you would be forced with either breaking the rule or abandoning a peer variable.

A master variable with peers cannot have less than two peer variables and no more peer variables than master values. If the master variable also has subvariables, then the number of peer variables must be equal to the number of master values. In other words, there must be one peer variable for each master value. This is necessary to simplify calculating the permutations. However, one of ordinary skill of the art recognizes the ability to allow the number of peer variables to not be equal to the number of master values.

When a master variable with peers has subvariables, a subvariable value is selected for each peer variable. In other words each peer variable has its own subvariable. Subvariable values are referenced using the syntax

{$variable.peervariable.subvariable}.

If the subvariable itself has covariables, then the subvariable value is referenced using the syntax

{$variable.peervariable.subvariable.subvariable}

and its covariable values are referenced with

{$variable.peervariable.subvariable.covariable}.

Permutations for a master variable with N peer variables and N values:

P=N!

A master variable with two peer variables and N values:

P=N*(N−1)

A master variable with V peer variables and N values where V<N:

P=N!÷(N−V)!

A master variable with k peer variables and one subvariable:

| A | B1 | B2 | B3 | B4 | |
|---|---|---|---|---|---|
| 1 | ✓ | ✓ | | | N₁ = 2 |
| 2 | | ✓ | ✓ | | N₂ = 2 |

. . .

| | | | |
|---|---|---|---|
| k | ✓ | ✓ | Nₖ = 2 |

Master = A;
Values = 1, 2, . . . , k
Peer variables = A₁, A₂, . . . , Aₖ
Subvariable = B;
Values = B1, B2, B3, B4
P_{AB} = k! * (N₁ * N₂ * . . . * Nₖ)

Where N₁, N₂, . . . , Nₖ define the number of valid subvariable values for each master value. Extending this equation to a master variable with k peer variables and two subvariables:

| A | B1 | B2 | B3 | C1 | C2 | C3 | |
|---|---|---|---|---|---|---|---|
| 1 | ✓ | ✓ | | ✓ | ✓ | ✓ | N_{B1} = 2; N_{C1} = 3 |
| 2 | | ✓ | ✓ | | ✓ | ✓ | N_{B2} = 2; N_{C2} = 2 |

. . .

| | | | | | | |
|---|---|---|---|---|---|---|
| k | ✓ | ✓ | ✓ | ✓ | ✓ | N_{Bk} = 3; N_{Ck} = 2 |

Master = A;
Values = 1, 2, . . . , k
Subvariable = B;
Values = B1, B2, B3
Subvariable = C;
Values = C1, C2, C3
P_{ABC} = k! * (N_{B1} * N_{C1}) * (N_{B2} * N_{C2}) * . . . * (N_{Bk} * N_{Ck})

The equation expands in the same manner with each additional subvariable:

P_{AB . . .} =k!*(N_{B1}*N_{C1}* . . . )*(N_{B2}*N_{C2}* . . . )* . . . *(N_{Bk}*N_{Ck}* . . . )

FIG. 5 is a flow diagram of the present invention. The flow diagram, at its most basic level, is comprised of two sections. The first section is the set-up process and the second part is the optimization process. The flow chart begins by identifying 42 the variables. In other words, the agency or content provider selects the areas or locations in the content that they desire to be altered or changed for different permutations of the content. The next step is to specify the expected performance 44. This is important at this point because it dictates or influences the sample size needed to get reliable results. The next step is a dual step in which the media plan 46 is created and the minimum optimization waves are given.

In the preferred embodiment, media plans are incorporated to control how and where creatives are served. They are the basis for runtime optimization. Each media plan has one or more media buys. Each media buy associates particular publishers and products with the media plan. The publisher and product chosen has a great deal of influence on the runtime optimization and also on how the results are reported postmortem. A media plan has one or more templates. The media plan can only run creatives of a single media format. This format determines which templates can be selected. Only creatives for the templates selected are run and optimized. Each template has a relative weight that controls the likelihood each template will be selected over other templates in the media plan. Creatives within templates are not weighted.

In the present invention, the minimum optimization waves dictate to the present invention how many cycles of optimizing the system performs in order to gather and report data. In reality, the preferred embodiment can perform an infinite number of optimization routines. However, in reality, a fixed number are needed to achieve a certain result level. The preferred embodiment incorporates both the media plan 46 and minimum optimization. In an alternate embodiment, it is possible to run the system without specifying the minimum cycles of optimization.

The next step is calculating the number of creatives 48, which is based upon the parameters chosen in the previous steps 42, 44, 46. The next step then figures which creatives to choose 50. For example, if the system calculates five million different creatives, a very large sample size is needed to optimize all these creatives. In many instances, the sample size is not available because of the traffic on the individual website or the time to gather such a sample size is too large. The present invention uses fractional factorial design to determine which creatives to use. Fractional factorial design is known in the art and is a process by which a permutation is selected and displayed from a sample population. For example, if there are a million advertisements, the fractional factorial design chooses the best minimal subset to run based upon a number of parameters. With the completion of the fractional factorial design 50, the preferred embodiment now has a limited number of creatives to test. The preferred embodiment uses fractional factorial design to choose among the various creatives. One of ordinary skill in the art recognizes the interchangeability of experimental design algorithms.

The next step, which is the beginning of the second section, is to run impressions against each creative 52. An impression is an instance of viewing a version of content. For example, if the system is testing a home page, each time a visitor sees the home page that would be an impression. If a content provider or agency is testing an advertisement, the impression would be each time the advertisement is viewed. In this step, the number of impressions is run against each creative to arrive at a sample that gives reliable results. In other words, enough impressions are run or accepted such that the statistical data is considered reliable. Up to this point, the creatives that were determined through fractional factorial design 50 are being run simultaneously.

At this point, the optimization is begun. In alternate embodiments, the optimization process is a form of a step-wise regression. In a step-wise regression analysis, regression equations are employed to find a best fit. This is done by adding and subtracting variables through different regression equations. The equation is then analyzed to determine its quality. The process is repeated or cycled a number of times to a degree that the a successful creative is determined.

In the first step of the optimization process, the most significant dummy variable is isolated 56. In this step, a correlation is made between each variable and click-thru rate or some other dependent variable. In the preferred embodiment, each variable is correlated with the click-thru rate. From this correlation, the preferred embodiment determines whether any of these variables are statistically significant or which one is most significant. The next step of a linear regression 58 is performed on the variable against a dependent variable such as the click-thru rate. The determination of the linear regression 58 is then analyzed to determine whether the value is significant at the threshold set 60. For example, a ninety to ninety-five percent threshold could be used. The threshold set 60 is essentially the point at which the content provider is statistically satisfied with the results. The certainty of the result in large part is based on the sample size. The sample size must be fairly large to ensure an actionable result. The decision then becomes what level of certainty the content provider can live within, which is based upon an acceptable margin of error. The higher ranges of certainty usually fall into scientific areas of research. In an ideal world, a ninety-five percent certainty is the minimum threshold.

If the threshold is not met, then the next step of inquiring whether there is another variable 62 is completed. If there is another variable, then the preferred moves to the next most significant variable 64 and proceeds to perform the linear regression 58 and use this determination to analyze if the threshold 60 has been met.

If there are no remaining variables 66, then the optimization determines if there are any optimization waves 46 remaining. If there are not, then the optimization is ended 68. If there are remaining waves left, then the optimization process creates a new batch of creatives 70. In the preferred embodiment, these new creatives are going to be based eighty-percent based upon the new equation formed from the optimization process. The final twenty-percent of the creatives is based upon the top creatives determined through the optimization process. Once they are generated, the variables are fed back into the fractional factorial design 50 and the optimization process is repeated.

An alternate embodiment uses one hundred percent of the new batch of creatives that were declared statistically significant through the optimization process. The system is not limited by either configuration. The preferred embodiment of the eighty and twenty percent was found to be the most successful in the marketplace.

If the threshold has been met, the variable is pinned 66 or fixed. In other words, the variable is not altered during subsequent creatives. Another linear regression analysis 74 is then performed by using this pinned variable against the rest of the variables. As in the beginning process, the results of this regression analysis 74 are then analyzed to determine which variable shows the greatest increase in statistical significance 76. Once the variable is isolated, this isolated variable 76 is then compared to the threshold 78. In other words, a comparison is made against the threshold 78, as in the previous threshold comparison 60. If the answer is no, then a determination is done as to the analysis of any remaining variables 80. If there are remaining variables, then the optimization process moves to the next most significant variable 82. This new value and it linear regression analysis is then compared to the threshold value 78.

If the optimization process has gone through all the variables, then the previous values are analyzed to determine if there is at least one value above the threshold 84. If the answer is no, the process checks if there are any remaining waves 86. If no, then the process is ended. If there is no value above the threshold, then no equation is set and the system is rechecked to see if there are any waves remaining 86. If not, then the process is ended. If there are waves remaining, the new batch of creatives is formed. These new creatives are going to be based eighty percent based upon the new equation formed from the optimization process. The final twenty percent of the creatives are based upon the top creatives. Once they are generated, the variables are fed back into the fractional factorial design 50 and the optimization process is repeated.

If in the second half of the optimization process, a variable is found significant at the threshold 78, then a determination is whether the previously pinned values are still above the threshold 90. If the answer is no, the a linear regression analysis is performed against the statistical significant variable only 92. If the values are statistically significant, another linear regression is done against the rest of the variable 74. If the value is not statistically significant, then the preferred embodiment reverts to the old equation.

What could happen during this second half of the optimization process is that by adding variables to the equation, the other variables that were statistical significant are no longer significant. An example of this is when a determination is made that variable x and variable y are significant. When z is put into the equation, z is significant but with the equation xyz, y and z are significant but x is no longer significant. Then a statistical determination is made as to whether the process should use the equation with x and y or y and z.

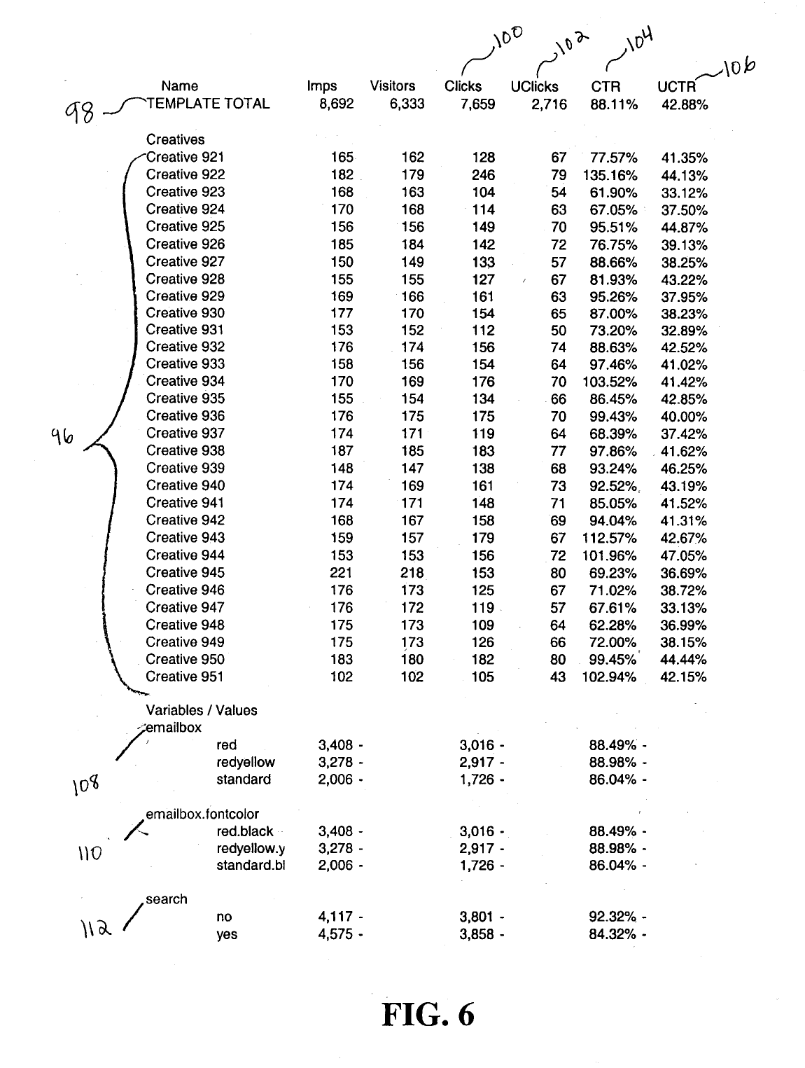

FIG. 6 is a report that illustrates the reporting tier of the present invention. The reporting tier allows an agency or content provider to see how their content is performing. For example, the template has a number of creatives 96 currently selected and presented to requesters. The report illustrates in the template total 98 that there have been 8,692 impressions for the data and out of these 6,333 have been new visitors, meaning that this is the first time that the visitor has seen the content. The click column 100 details how many of the impression have been requested something particular within the content. For example, the click can illustrate a specific area of the content in which the requestor advances to different URL. The next column, UCLICK 102, reports how many of the clicks 100 were unique. In other words, how many were requesting the content for the first time.

In this specific example, the agency or content provider has defined their reporting tier to detail the click-thru rate (CTR) and the unique click-thru rate (UCTR). The CTR column 104 is determined by dividing the impressions (8,692) into the clicks (7,659) 100. The percentage in this case is 88.11%. The UCTR column 106 is determined by dividing the visitors (6,333) into the UCLICKS 95. This percentage is 42.88%.

In this report, the content provider assess the content with the current template has been provided 8,692 times with 6,333 of them being unique. Those that have seen the content then request further information by clicking a specific area of the content. The number of clicks is 8,659 with the unique clicks being 2,716. The statistics state that there is a click rate of 88.11% however, only 42% of them are new or unique requests.

This report also provides variables for an e-mail box 108 and its font attribute 110 and a search feature 112. The report provides the value chosen and the number of times it was viewed by requesters. The values provide the content provider with statistical evidence as to which value provided the best response.

In the above example, the preferred embodiment illustrates monitoring the creatives 92 by the click-thru rate. Each of the creatives 96 is a differing permutations of the content. Each creative is monitored as to its own effectiveness or success rate. Note, however, that the reporting feature is tailored to accommodate the content provider's request. A good example of this is a technical site that provides technical assistance. A success rate for this content could be the least number of e-mails received to provide technical assistance. Therefore, the report received by the agency or content provider would provide number of e-mails received.

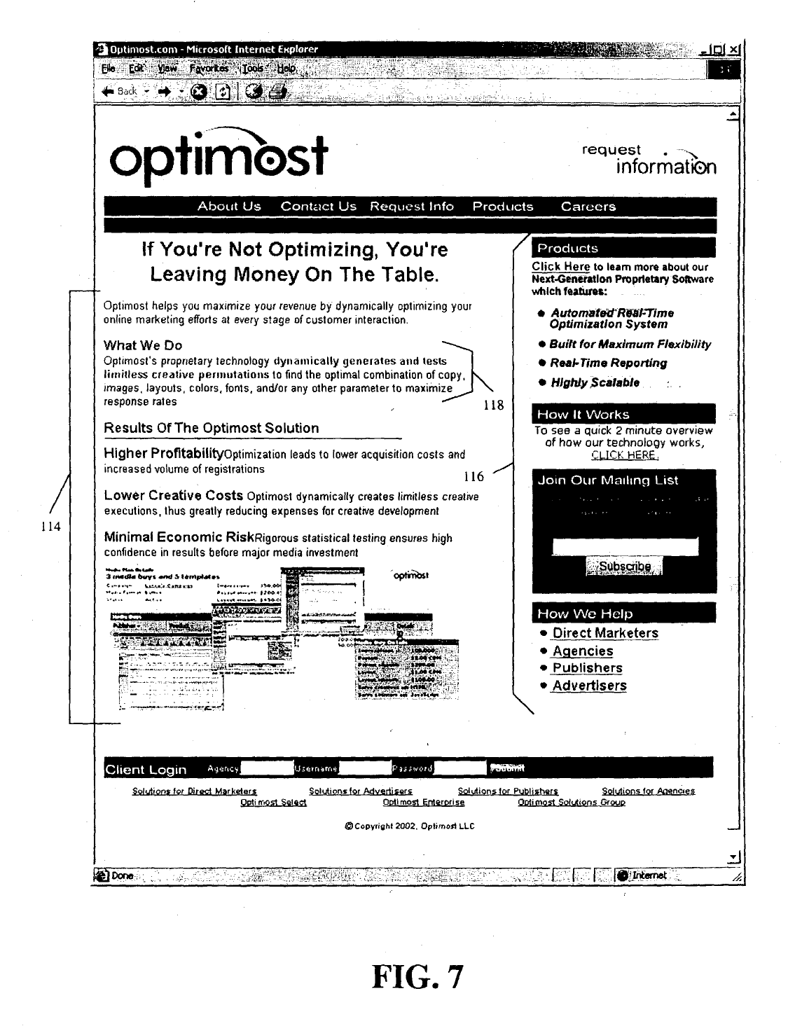

FIG. 7 is an illustration of an embodiment of the invention. In this embodiment, a website home page is displayed. The content contained within the website, such as the text, links and all else is placed within a template. Variables are then selected or identified within the content. In this example, a variable is selected to arrange the placement of the content. Column A content 114 and column B content 116 are both selected as a variables to which their arrangement is altered with subsequent requests for data.

The second block of text 118 in column A content contains the variable font attribute for bolding the phrase “dynamically generates and tests limitless creative permutations.”

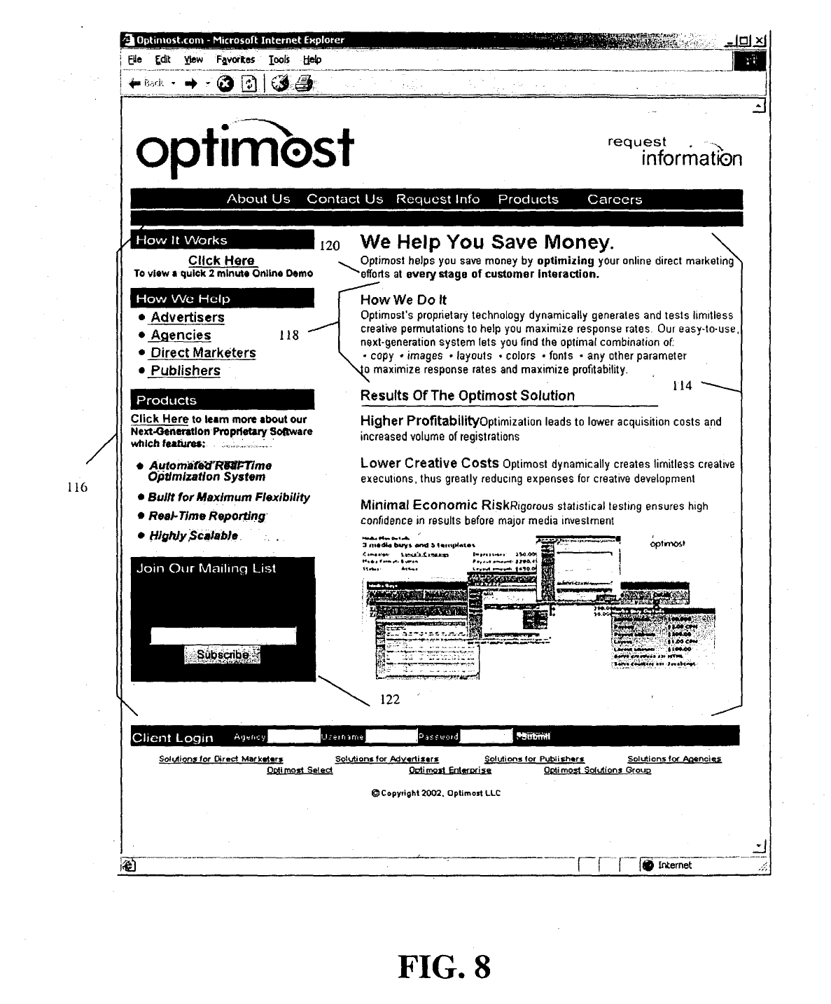

FIG. 8 is an alternate embodiment of FIG. 8. In this figure, a request is sent to website requesting access to the system In reply, the computer transmits data to the requester. In this instance, the present invention provides an alternate permutation of the data. In this figure, column A content 114 and column B content is shifted from their position in FIG. 8. This is accomplished by the variable placed in the template as to the placement of this data.

Other variables that were placed within the template is the first text block 120 in the column A data. In this permutation, the variable is the altering of the font attributes of certain words. The font attributes bold the words “optimizing” and “every stage of customer interaction.”

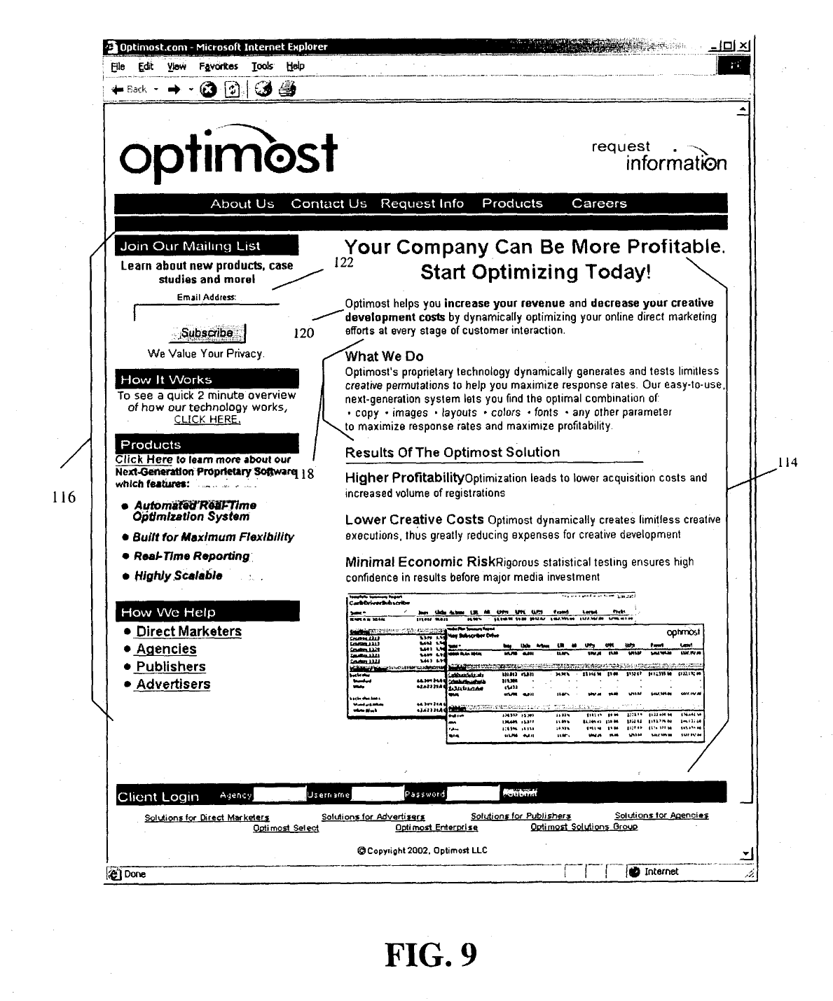

Another variable placed within the content and is altered in FIG. 9 is the placement of the data in column B content 116. For examples, the mailing list registry 108 is moved to the bottom of the column as opposed to its location in FIG. 8.

The variable font attribute of the second block of text 120 does not apply the bold attribute to the phrase as was done in FIG. 8. However, the second block of text 118 in column A content is altered to include listing of elements, i.e. copy, images, etc... such that they are broken out and separated with characters.

FIG. 9 is an alternate permutation of the content of FIG. 8. In this example, the columns of content 114, 116 are placed in the same arrangement as in FIG. 9. Additionally, the font attributes variable are also selected for the first block of text in the column A content 114.

The content is column B content is arranged in a different manner as well. The mailing list registry 108 is altered in that the colored background is not selected. In other words, a white background is used in its place.

The preferred embodiment is actuated with software code that is embedded or stored on a computer medium. The medium is connected to an Intel compatible processor, which executes the code. The computer device, in the preferred embodiment, is an IBM compatible computer with a Linux based operating system.

The present invention encompasses many differing embodiments in which electronic content is capable of being altered. Some of these alternate embodiments would include but not limited to optimizing and dynamically generating billboards and other out-of-home advertising devices, optimizing and dynamically generating kiosks, optimizing and dynamically generating magazines, newspapers, direct mail and other printed materials, optimizing and dynamically generating television and radio advertisements, optimizing and dynamically generating signs, optimizing and dynamically generating games, optimizing and dynamically generating puzzles, optimizing and dynamically generating interactions screens, optimizing and dynamically generating literature, optimizing and dynamically generating other advertising materials, optimizing and dynamically generating menus, prices, pricelists and other in-store or in-restaurant materials, optimizing and dynamically generating presentations, comedy acts, and other performance materials based on feedback, optimizing and dynamically generating artwork, architectural plans, and other creative materials, and optimizing and dynamically generating streaming data.

The many features and advantages of the invention are apparent from the detailed specification, and thus, it is intended by the appended claims to cover all such features and advantages of the invention, which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method for altering electronic content, comprising:
placing content within a template;
placing at least one or more variables within the template;
choosing a plurality of values for the variable; and
calculating permutations for the content based upon the values.

2. The method as in claim 1, further comprising the step of transmitting the permutations to a requester.

3. The method as in claim 2 further comprising the step of evaluating the permutations.

4. The method as in claim 3, further comprising optimizing the number of the permutations.

5. The method as in claim 4, wherein the step of optimizing comprises reducing the permutations to a new set of permutations.

6. The method as in claim 5, wherein the new set of permutations is derived from the step of evaluating the permutations.

7. The method as in claim 6, wherein the step of evaluating the permutations is based upon the best effectiveness.

8. The method as in claim 5, further comprising the step of transmitting one of the new sets.

9. The method as in claim 8, further comprising the evaluating the new set of permutations.

10. The method as in claim 1, wherein a plurality of variables cannot be equal.

11. The method as in claim 1, wherein the plurality of variables relate to one another.

12. The method as in claim 1, further comprising the steps of selecting a covariable for the variable and choosing a value for the covariable.

13. The method as in claim 1, further comprising the step of selecting a peer variable for a master variable and choosing a value for the peer variable.

14. The method as in claim 1, further comprising the step of selecting a subvariable that is dependent on the master value and choosing a value for the subvariable.

15. The method as in claim 4, wherein fractional factorial design is used to optimize the permutations.

16. The method as in claim 1, further comprising the step of dynamically selecting a new permutation each time it is accessed.

17. An apparatus for altering electronic content, comprising:
means for placing content within a template;
means for placing at least one or more variables within the template;
means for choosing a plurality of values for the variable; and
means for calculating permutations for the content based upon the values.

18. The apparatus as in claim 17, further comprising means for reducing the number of the permutations to a new set.

19. The apparatus as in claim 18, further comprising means for transmitting one of the new set.

20. The apparatus as in claim 19, further comprising means for evaluating the new set of permutations.

21. The apparatus as in claim 17, wherein the template is a control template.

22. The apparatus as in claim 17, wherein a plurality of the variables cannot be equal.

23. The apparatus as in claim 22, wherein the plurality of the variables relate to one another.

24. The apparatus as in claim 17, further comprising means for selecting a covariable for the variable and means for choosing a plurality of values for the covariable.

25. The apparatus as in claim 17, further comprising means for of selecting a peer variable for a master variable and choosing a value for the peer variable.

26. The apparatus as in claim 17, further comprising a means for dynamically selecting a new permutation each time it is accessed.

27. The apparatus as in claim 17, further comprising means for selecting a subvariable that is dependent on the master value and choosing a value for the subvariable.

28. A computer readable medium containing executable code for altering electronic content, comprising:
placing content within a template;
placing at least one or more variables within the template; and
calculating permutations for the content based upon the values.

29. The computer readable medium as in claim 28, further comprising the step of transmitting the permutations a single one at a time.

30. The computer readable medium as in claim 29 further comprising the step of evaluating the permutations.

31. The computer readable medium as in claim 30, further comprising reducing the number of the permutations to a new set.

32. The computer readable medium as in claim 31, further comprising the step of transmitting one of the new set.

33. The computer readable medium as in claim 32, further comprising the evaluating the new set of permutations.

34. The computer readable medium as in claim 28, wherein the template is a control template.

35. The computer readable medium in claim 28, wherein a plurality of variables cannot be equal.

36. The computer readable medium as in claim 35, wherein the plurality of variable relate to one another.

37. The computer readable medium as in claim 30, further comprising the steps of selecting a covariable for the variable and choosing a values for the covariable.

38. The computer readable medium as in claim 28, further comprising selecting a peer variable for a master variable and choosing a value for the peer variable.

39. The computer readable medium as in claim 28, further comprising dynamically selecting a new permutation each time it is accessed.

40. The computer readable medium as in claim 28, further comprising selecting a subvariable that is dependent on the master value and choosing a value for the subvariable.

41. An computer processing device for optimizing electronic content, comprising:
a memory location wherein the content is located;
a selector linked to the memory location, wherein the selector allows at least one or more variables to be placed within the content;
an identifier linked to the selector, wherein the identifier allows a plurality of values to be chosen for the variable;
a generator linked to the memory location, selector and the identifier, wherein the generator creates permutations for the content based upon the variable and the plurality of values;
a transmitter linked to the generator that transmits one of the permutations to a requestor; and
an evaluator linked to the generator linked to the generator.

42. The apparatus as in claim 41, further comprising a receiver configured to receive a request from the requester for access to the content.

43. The apparatus as in claim 41, further comprising an optimizer is linked to the generator and evaluates the permutations.

44. The apparatus as in claim 43, wherein the evaluation of the permutations is based on a content provider defined effectiveness measure.

45. The apparatus as in claim 43, wherein the optimizer reduces the number of the permutations available to the requestor.

46. An apparatus that organizes electronic content in preparation for dynamically altering the content, comprising:
a template that stores the content;
a variable assignor linked to the template;
a value assignor linked to the variable assignor.

47. The apparatus as in claim 46, further comprising a generator linked to the template.

48. A method for organizing electronic content in preparation for dynamically altering the content, comprising the step of:
storing the content in a template;
assigning a variable to the template; and
assigning a plurality a values to the variable.

49. The method as in claim 48, further comprising the step of generating permutations of the content based on the variable and values.

50. The method as on claim 48, wherein the variable is selected from the group consisting of a peer variable, covariable or a subvariable.
